(19) United States
(12) Patent Application Publication
(10) Pub. No.: US 2013/0106191 A1
(43) Pub. Date: May 2, 2013

(54) RENEWABLE MOBILE RESOURCE STATION

(71) Applicants: Claudia Iovino, Boca Raton, FL (US); Harvey Katz, Boca Raton, FL (US); Jonathan Iovino, Boca Raton, FL (US)

(72) Inventors: Claudia Iovino, Boca Raton, FL (US); Harvey Katz, Boca Raton, FL (US); Jonathan Iovino, Boca Raton, FL (US)

(21) Appl. No.: 13/559,553

(22) Filed: Jul. 26, 2012

Related U.S. Application Data
(60) Provisional application No. 61/511,757, filed on Jul. 26, 2011.

(51) Int. Cl. H02J 4/00

(52) U.S. Cl. CPC H02J 4/00
USPC 307/72

(57) ABSTRACT

The renewable mobile resource station of the present disclosure may contain all or some of the following systems: self-contained, self-sustaining, mobile renewable power systems, employing solar, wind, internal combustion, diesel, and other portable power generation systems. The enclosed portable station may also preferably include portable resource systems such as water purification and storage systems; chemical and biological water treatment and waste treatment systems; lighting; heating and cooling systems; refrigeration; cooking systems; communication systems; and fire and chemical/biological containment systems. A control module and system may be provided to control the separate systems either on-site or remotely, or automatically such as by a software program.

### CROSS REFERENCE TO RELATED APPLICATION

This application claims the benefit of U.S. Provisional Application No. 61/511,757 filed Jul. 26, 2011, herein incorporated by reference in its entirety for all purposes.

### FIELD OF THE INVENTION

This invention relates to systems which provide mobile utility services where such services are either otherwise unavailable or interrupted.

### BACKGROUND OF THE INVENTION

A known problem exists with safely and efficiently providing educational, nutritional, humanitarian or military aid or other emergency services in remote areas where no utility services are available or unreliable, or in areas afflicted by natural or manmade disasters where utility services have been interrupted. In addition, it is sometimes necessary to conduct research and other such activities in remote or environmentally sensitive areas where no utility services are readily available. Utility services generally include water, electricity, communications, and the like.

In such instances where utilities services are required, it has been known to obtain individual component systems to provide power, purified water, communications, and cooking/housekeeping/sanitary facilities from separate sources which most often operate independently. Such systems must be obtained, transported to the required location, set-up, operated, and then subsequently taken down, transported and/or stored independently of each other. Although such independent systems can generally be expected to operate as designed in an independent manner, problems arise when integration is necessary such as when cooking and/or communications equipment have power or connection requirements which are not compatible with the power generation equipment. Accordingly, a need exists for a modular self-contained scalable mobile system for providing such utility services. A need also exists to provide such utility services in a rugged and protected housing. In addition, there is a need for providing such services so that the separate utility components are fully compatible and operational under rapid response deployment requirements.

### SUMMARY OF THE INVENTION

The present disclosure defines a renewable mobile resource station for providing utility services such as power, potable water, cooking facilities, communications equipment and the like. In the system of the present disclosure, many of the separate and distinct elements are commercially available; however, the system of the present disclosure provides such separate elements in a complete, cost-effective system which is a highly transportable, completely compatible, and rugged resource station. In this way, the station of the present disclosure can be transported to an area where utilities are not otherwise available, or where utility service has been interrupted, and set-up in a rapid manner such that all components cooperate together so as to be available to provide the power, resource, water, communication, and other needs in an efficient manner. It is contemplated that the renewable mobile resource station of the present disclosure may be capable of use in the following exemplary environments which include small isolated communities and developing countries and/or locations having no connection to a reliable electrical grid or resource; recreational, research, construction and industrial applications in areas where utilities are unavailable or interrupted; humanitarian aid such as disaster relief from natural or manmade disasters such as FEMA disaster relief in the event of hurricane, tsunami, flood, tornado, or the like; USAID refugee camps and other national and international humanitarian efforts; military and defense mobile utility, power and communication efforts; and educational mobile laboratories.

The renewable mobile resource station of the present disclosure may contain all or some of the following systems: self-contained, self-sustaining, mobile renewable power systems, employing solar, wind, internal combustion, diesel, and other portable power generation systems. The enclosed portable station may also preferably include portable resource systems such as water purification and storage systems; chemical and biological water treatment and waste treatment systems; lighting; heating and cooling systems; refrigeration; cooking systems; communication systems; and fire and chemical/biological containment systems. A control module and system may be provided to control the separate systems either on-site or remotely, or automatically such as by a software program.

These and other aspects, objects, features and advantages of the renewable mobile resource station of the present disclosure will become more fully apparent upon careful consideration of the following detailed description of the preferred embodiment and any accompanying drawings. The disclosure may further provide methods and structures of varying scope.

### BRIEF DESCRIPTION OF THE DRAWINGS

FIG. 1 is a perspective view of one embodiment of a renewable mobile resource station of the present disclosure.

FIG. 2 is a front plan view of a renewable mobile resource station of the present disclosure depicting one embodiment for deploying auxiliary solar arrays.

FIG. 3 is the renewable mobile resource station of FIG. 2 with the auxiliary solar arrays stowed for travel.

FIG. 4 is a prospective view of an exemplary wind turbine for use with a renewable mobile resource station of the present disclosure.

FIG. 5 is a block diagram of the power system for a renewable mobile resource station of the present disclosure.

### DETAILED DESCRIPTION OF THE PREFERRED EMBODIMENTS

The renewable mobile resource station according to the present disclosure is a mobile, self-contained, scalable, and rugged system that provides immediate availability of utility resources such as electrical power, potable water, communications, cooking facilities, lighting, heated or cooled air, and the like. Embodiments of the renewable mobile resource station could include multiple combinations of any of the above systems contained and packaged in one unit, such as a rugged trailer housing assembly such that the station can be easily transported, and quickly and completely assembled so as to provide power, lighting, cooking, communications and other utility requirements in remove and/or emergency response situations. The renewable mobile resource station of the present disclosure is easy and cost-efficient to transport and operate and is fully fueled by solar, wind, or other known power methods and can be deployed anyplace in the world as required for immediate, renewable, power where such power may be unavailable, interrupted, or unreliable, or where one wants to simply be “off the grid.”

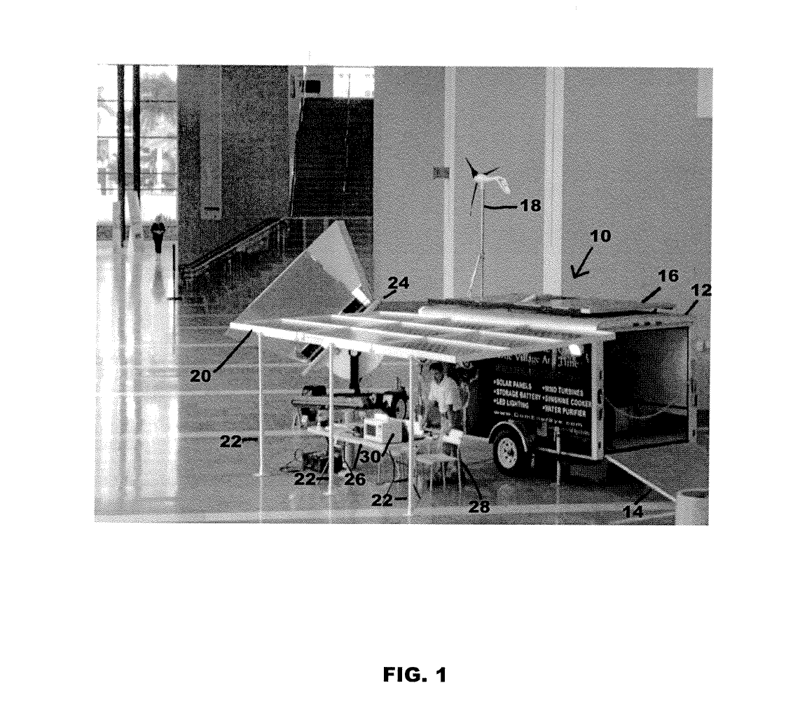

With reference to FIG. 1 a renewable mobile resource station 10 of the present disclosure is depicted. The renewable mobile resource station 10 includes generally a mobile enclosure, housing or trailer 12 which serves to contain the system components of station 10. Trailer 12 could be configured in any required manner. In addition, station 10 of the present disclosure is scalable such that trailer 12 could be of any size or configuration suitable for a required application. In addition, trailer 12 could be configured in a manner such that the structure is reinforced and includes enhanced suspension and tire systems so as to be taken off-road and in remote locations. In a preferred embodiment, the floor of trailer 12 in station 10 includes a metal sub-floor plate, preferably on the exposed bottom portion for protection against ground material penetrating the floor of trailer 12 such as tree branches, rocks, or even small improvised explosive devices (IED's), etc. Trailer 12 may include a ramp 14 which folds down to access the interior of trailer 12 and provide a ramp for easy removal and insertion of system components within the housing of trailer 12. Ramp 14 preferably forms the rear enclosure of trailer 12 when secured for transport. Trailer 12 may include all necessary lighting, braking, and other accessories necessary for legal road travel in any particular geographic location.

The mobile enclosure/trailer of the renewable mobile resource station of the present disclosure preferably includes the following specifications:
Custom off road heavy duty under carriage including 5,000-6,000 lb frame, heavy duty axels, heavy duty leaf springs, and electric brakes
Large tires/16 to 18 inch preferred.
6 in Extra Height/LTF: Inside has 6 ft 6 inch clearance
Convenience Package Includes: (1) 12v Dome Light w/Wall Switch, (2) Flow Thru Vents, 24 in ATP Front Stoneguard and (2) Stainless Steel Center Caps
Sound Insulation for better reception and communications
Med Duty Ramp with Anti-Slip Protection
54 in Triple Tube Tongue; ILO Std/EA (removable of security—anti theft)
LTF Undercoating applied to wall as well as frame to protect against sand, dirt and rusting
Corner Post Drop Down Jacks with holes for grounding and stability stakes 3000#/PR
R5 Fiberglass Ceiling sound proofing LTF Insulation/LTF
R5 Fiberglass Wall Insulation/LTF
Kemlite Smooth Wall
Lauan Ceiling/LTF LTF
60A Breaker Box w/110v Lifeline GWS model GWS2100 has 2 Breaker Boxes for independent power backup
Cable Hatch/EA Notes: Plastic Cable Access Hatch (Large)—30 or 50 amp shoreline access doors. May include redundancy systems
ATP Floor Runner/Sq Ft; 12″ tall on side and front walls
3-6 Brackets for Solar Panels
4-6 LED Exterior Lights
Wall and under floor protection could be added as desired/required
Hurricane tie down systems could also be added

In order to provide power services, it is contemplated that two main systems including solar panels 16 as well as a wind turbine 18 may be supported from trailer 12 in order to generate electricity from solar power or wind power in known ways. In addition, station 10 may include an awning 20 which may be supported from trailer 12 on one side and supports collectively 22 on the other. Awning 20 preferably includes solar panels on its top surface so as to provide additional surface area for collection and generation of solar power. In addition, awning 20 provides a work space underneath which is shaded and protected from the elements.

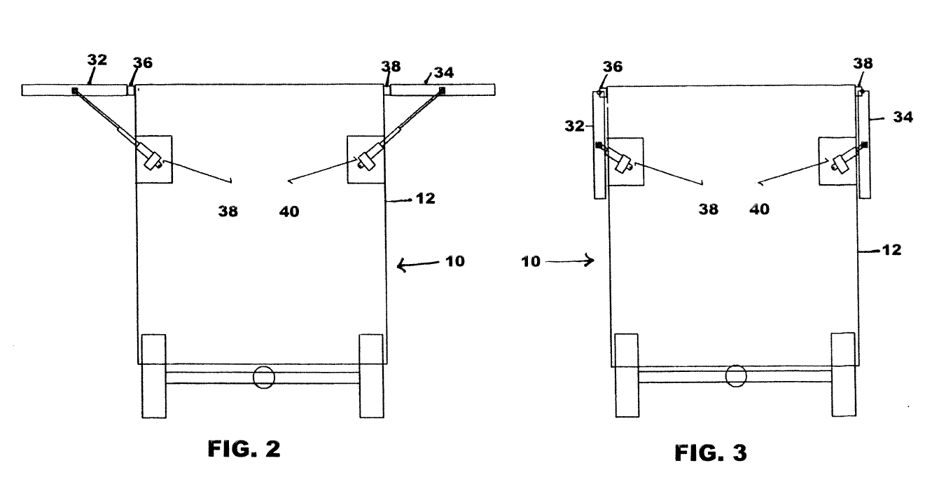

With reference to FIGS. 2 and 3 which are schematic representations of a renewable mobile resource station 10 from a front view. FIG. 2 depicts an alternative embodiment for the storage and deployment of additional auxiliary solar panels. Auxiliary solar panels 32 and 34 may be attached to trailer 12 such that they are capable of deployment and then retraction for storage and transport. Auxiliary solar panels 32 and 34 may be attached to trailer 12 by hinge mechanisms 36 and 38. A deployment mechanism, such as screw jacks 38 and 40 may be secured to trailer 12 on one end and to auxiliary solar panels 32 and 34 at a second end. Screw jacks 38 and 40 are capable of extension such that when extended auxiliary solar panels 32 and 34 are deployed so as to be level with the top surface of trailer 12. Alternatively, as shown in FIG. 3, screw jacks 38 and 40 may be retracted so as to withdraw auxiliary solar panels 32 and 34 so that they are perpendicular to the top surface of trailer 12 and thus flush with the side surfaces of trailer 12 for storage and transport. It is contemplated that a second set of screw jacks (not shown) would be placed on the rear of trailer 12 or along the length of the sides of trailer 12 in order to provide additional support for auxiliary solar panels 32 and 34. It is further understood that additional solar panels would be placed on the top of trailer 12 such that when the auxiliary solar panels 32 and 34 deployed a substantial surface area is present to collect solar energy. In an alternate embodiment, the auxiliary solar panels 32 and 34 may slide over the top of the photovoltaic arrays on the top of trailer 12. In this embodiment screw jacks may be positioned to deploy or retract (slide) the auxiliary panels 32 and 34 outward or inward as required.

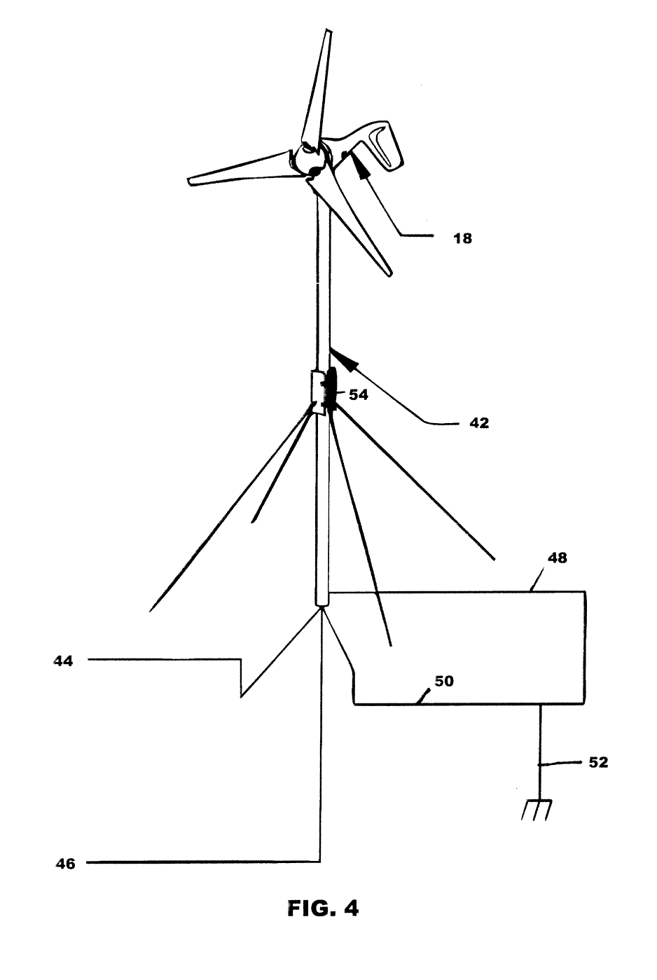

With reference to FIG. 4, an exemplary wind turbine for use with the renewable mobile resource station 10 of the present disclosure shall next be described. As depicted wind turbine generator 18 may be secured to a tower 42 and secured to trailer 12 as shown in FIG. 1. Wind turbine generator 18 would be electrically connected to the renewable resource station 10 via a positive electrical connection 44 and a negative electrical connection 46. Electrical grounds would be provided for the tower at 48 and for the turbine 50 which could be grounded to the earth at 52. In addition, tower 42 may include an antenna array 54 for radio or such related communication purposes.

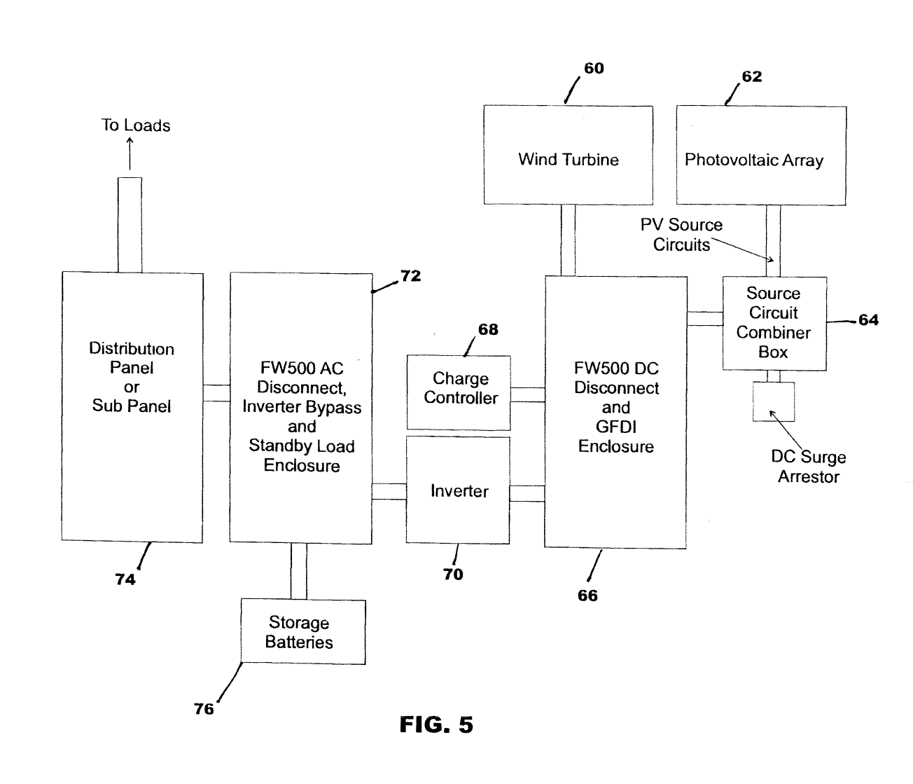

FIG. 5 depicts a block diagram for the power generation and control system for the renewable mobile resource station of the present disclosure. With specific reference to FIG. 5, power is generated by either wind turbine generator 60 or by photovoltaic array 62. The electrical energy harnessed from multiple photovoltaic arrays 62 is combined at a source circuit combiner box 64. Electrical energy from both wind turbine 60 and the photovoltaic array source circuit combiner box 64 pass through a DC breaker and ground fault detection enclosure 66 which includes a charge controller 68 and into inverter 70. From inverter 70 electrical energy may pass through an AC disconnect, inverter bypass and standby load breaker 72 to either distribution panel or subpanel 74 and onto supply energy to an electrical load or to a storage battery array 76 for use at a later time to supply electrical energy to an electrical load. It is evident, the power control system is capable of either operation “on grid” or “off grid” as necessary. For example, power could be derived from an electrical grid or from the portable power generator systems such as a generator or the photovoltaic arrays or the wind turbine generator.

Power generated from solar collectors 16 and power wind turbine 18 may be stored in a battery bank contained within trailer 12. Power may be accessed directly, or through an inverter through standard electric outlets positioned on or supported from trailer 12 which may include any power requirements/configurations as necessary for a particular geographic application. Power generated and stored by station 10 may be employed for lighting applications which may include high efficiency lights such as weatherproof LED flood lights or the like. In addition, additional rechargeable lanterns may be supplied in station 10.

Power may also be directed to systems such as portable water purification systems housed within trailer 12 of station 10. Such portable water purification systems are available commercially and can be adapted for application in trailer 12 in order to provide a source of potable water.

An exemplary preferred water purification system for use with the station of the present disclosure is a Stationary, Wall Mount Solar Battery 12-volt Powered Water Purification System designed for Remote Applications. This system has the capabilities of producing cleaner and safer drinking water from almost any creek, stream, pond, well, lake or most any fresh water source at a volume production rate of 10 gallons (37 liters) per minute where water purification and electrical power are impractical or unattainable. The daily water production from the solar battery mode is up to 1,800+ gallons (6,600+liters) per day. This System does not require any outside electrical power; nor is there a need for chemical additives.

These preferred Stationary, 12-volt Powered Water Purification Systems pull the water from the source and through a 5.0 micron Sediment Pre-Filter. The water is then pushed through a Carbon Block Polishing Filter that has the capabilities of removing Giardia and Cryptosporidium Cysts, Herbicides, Pesticides, Trihalomethanes (THMs), certain Volatile Organic Chemicals (VOCs), Chlorine and Chlorine By-Products, Sediment, Bad Taste, Odors, Color, Smell, and many other Harmful Chemicals and Contaminants down to a 0.5 micron. The polished filtered water is then channeled past an Ultraviolet Light Disinfecting Process that has the ability to kill Bacteria, Viruses, Typhoid Fever, Coliform, Dysentery, Cholera, Infectious Jaundice, Hepatitis & Influenza Virus, E-coli, Enteric Fever and many other unwanted microorganisms to a 99.999% purity. The preferable water purification system may have the following specifications:
6-10 gallon (37 liters) per minute
Installation time under 1.5 hour
Stationary Wall Mount with Mounting Flange 27″ wide×30″ long×8″ deep
40 lbs.
Power Sources: Solar Charged Battery=180 minutes up to 360 minutes

Additionally, power may be used for refrigeration of food, medical supplies, or the like or may be employed for other air treatment systems such as air conditioning or heating systems which may be portable and installed in trailer 12.

Station 10 may also include a cooking facility such as a solar cooker 24. Cookers such as solar cooker 24 are known in the art and may be capable of large cooking functions for serving multiple meals for a group of people as may be required. Multiple miscellaneous equipment such as tables 26, chairs 28 may be supplied with station 10. In addition small appliances such as microwave ovens 30 or the like may also be supplied.

Communications systems including communications antennas, satellite antennas and the like are contemplated for inclusion within station 10. In addition, computer systems are contemplated which may have access through the Internet or other global or network communication system with other computers or computer networks such as for educational, military, or research applications. Cell phone and other such battery charging stations are contemplated to maintain communications as necessary.

An operation and monitoring system may be supplied with station 10 which may operate the systems for greatest efficiency and output and may be operated manually, automatically, such as through software, or even remotely via the Internet.

The renewable mobile resource station 10 is a self-contained, self-sustaining, mobile renewable power system which provides electricity, water purification, lighting (including LED lighting), refrigeration, cooking equipment, all serviced with solar and wind power. In this way, a system having the following components is contemplated: immediate power upon deployment; solar panels, generating up to 3600 watts; small wind turbine, generating up to 1600 watts; 4.5 to 9.0KWH battery storage; water purification system; 4.5 cu. ft. refrigeration; LED lighting; sunshine solar cooker™=up to 1,200 meals/day; 110AC; cell phone recharging/battery power; fire extinguisher; power for instant communications; complete assembly in approximately 60-90 minutes.

An exemplary station of the present disclosure is depicted in the following table. The 110V AC exemplary station is ready to provide renewable off grid or on grid energy anywhere in the world, fuelled by the sun and wind. It should be understood, however, that the following specifications are for the purpose of exemplification only and other components could be easily substituted. An embodiment of the renewable mobile resource station 10 of the present disclosure may be configured as:

| | |
|---|---|
| Storage Trailer | Dimensions: 7′ × 12′ |
| | Tires: All Terrain |
| | 5,000-6,000 lb. frame, heavy duty axels, heavy |
| | duty leaf springs, electric brakes |
| Solar Array | Number of Modules: 12 Cell type: |
| | Monocrystalline |
| | Watts per module: 220 watts peak power |
| | Total array watts: 2,640 watts |
| | ±kWh per day*: 9.8 kWh |
| Wind Turbine | Rated Power: 400 watts at 28 mph |
| | Voltage: 48 VDC |
| | kWh per month: 38 at 12 mph |
| | Survival Wind Speed: 110 mph |
| | Marine Grade |
| | Warranty: 3 years |
| Power Inverter | Surge: 6,000 VA |
| | Rated Output: 3,600 VA |
| | AC Voltage: 120 volts VAC 60 Hz |
| | Efficiency: 93% |
| | Rated Amps: 30 A |
| Charge Controller | Max Amps DC: 80 A |
| Battery Bank | Capacity (20 Hr Rate): 108 Ah |
| | Bank Voltage: 48 VDC |
| | Bank Storage: 5.2 kWh |
| | Type: AGM |
| | Maintenance Free |
| | 100% Recyclable |
| Monitoring System | Creates and stores performance logs |
| | Can be accessed remotely |
| Standard Electric | Voltage: 110 VAC |
| Outlets | Current: 15 Amps (limited by circuit breaker) |
| Weatherproof 99 LED | Power usage: 6.5 Watts |
| Floodlights | Voltage: 12.5 VDC |
| | Lifetime: 30,000 Hours |
| Portable Water Purifier | Rate: 10 gallons (37 liters) per minute |
| | Power: Solar charged battery or external 12 VDC |
| | Capacity on solar battery: up to 18,000 gal+ (6,600 |
| | liters+) per day |
| | Capacity on external power: 720+ gallons per day |
| | Does not require external power, nor are chemical |
| | additives required. |
| Refrigerator | Capacity: 4.5 cu. ft. |
| | Voltage: 110 VAC |
| | Current: 1.3 Amps |
| 25 LED Rechargeable | Portable lighting for many uses |
| Lanterns | |
| Recharging station with | Recharge cell phones, power tools, lanterns, etc. |
| 18 outlets | |
| 25 Sunshine Family | Sunshine Community Solar Cooker also available |
| Cookers | |
| Fold down Table and 2 | |
| chairs | |
| Fire extinguisher | |
| Spare parts | Solar panel, water filters, etc. |

It is understood that other component systems may be included, and particularly waste treatment facilities, advanced life saving and medical equipment, or the like. The exemplary station is preferably equipped with: PV solar panels, wind turbine, battery bank, charge controller, power inverter, water purification system, LED lighting, solar cooker, cell phone and battery device charging station, cooking pots, spare parts. The station provides self-contained, easily transported light, power communication and solar cooking in a rugged portable container.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed:

1. A renewable mobile resource system:
comprising a mobile enclosure capable of transport in rugged conditions;
said mobile enclosure capable of receiving electrical power alternatively from an electrical grid and portable power generator sources,
said mobile enclosure capable of dispensing electrical power to resource systems capable of transport within said mobile enclosure.

2. The renewable mobile resource station of claim 1 wherein said portable generator sources include at least one photovoltaic array

3. The renewable mobile resource station of claim 2 wherein said at least one photovoltaic array is supported from said mobile enclosure.

4. The renewable mobile resource station of claim 1 wherein said portable generator sources includes at least one wind turbine generator in electrical communication with said mobile enclosure.
